(19) United States
(12) Patent Application Publication
(10) Pub. No.: US 2012/0269930 A1
(43) Pub. Date: Oct. 25, 2012

(54) COMPOSITION COMPRISING A LIPID SUITABLE FOR HUMAN CONSUMPTION

(75) Inventors: Jürgen Gierke, Illertissen/Betlinshausen (DE); Bettina Schwaier, Munchen (DE); Arne Ptock, Neuss (DE); Katja Beck, Illertissen (DE)

(73) Assignee: COGNIS IP MANAGEMENT GmbH, Dusseldorf (DE)

(21) Appl. No.: 13/508,617

(22) PCT Filed: Nov. 2, 2010
(86) PCT No.: PCT/EP2010/006668

§ 371 Date: May 8, 2012

(30) Foreign Application Priority Data
Nov. 10, 2009 (EP) EP09014031

(51) Int. Cl. A23D 9/00; A23L 1/303; A23L 1/302; C11B 5/00; A23D 9/02; A23L 1/236

(52) U.S. Cl. 426/73; 426/601; 426/548; 426/72; 426/545; 426/542; 426/541

(57) ABSTRACT

The present invention relates to a composition comprising at least one lipid suitable for human consumption, at least one water soluble sweetener, and at least one solubilizer, wherein water soluble sweetener means that at least 2 g sweetener are soluble in 1 l of water at a temperature of 20° C.

The present invention relates to a composition comprising at least one lipid suitable for human consumption, at least one water soluble sweetener, and at least one solubilizer, wherein water soluble sweetener means that at least 2 g sweetener are soluble in 1 l of water at a temperature of 20° C.

Lipids suitable for human consumption with special nutritional value, such as omega-3 rich oils or CLA (conjugated linoleic acid), are frequently formulated in soft gelatine capsules, as emulsions or as pure oils for oral consumption. Oil soluble flavours are frequently added to these supplements in order to improve the taste.

The problem underlying the present invention is to provide further compositions comprising at least one lipid suitable for human consumption which do not have an unwanted oily or cardboard-like taste or which have an oily or cardboard-like taste that is at least reduced compared to the oily or cardboard-like taste of the pure lipid suitable for human consumption that is comprised in the composition.

This problem is solved by the compositions according to the claims. These compositions are therefore subjects or preferred embodiments of the present invention. The use of a combination of at least one water soluble sweetener as defined in any of the claims and at least one solubilizer as defined in any of the claims and optionally at least one flavour as defined in any of the claims for masking the oily taste of at least one lipid suitable for human consumption as defined in any of the claims is a further subject of the present invention.

According to the present invention a triglyceride is an ester of one molecule of glycerol with three fatty acid molecules. The three fatty acid molecules may be identical or they may be different. Triglycerides are often mixtures of several molecules rather than pure compounds.

A fatty acid according to the present invention can be any fatty acid. In one embodiment of the present invention fatty acid means any fatty acid having 10 to 30 carbon atoms.

An omega-n fatty acid is a fatty acid having at least one double bond. The double bond is between C-atom no. n and n+1 if the C-atom of the methyl-group of the fatty acid is C-atom no. 1. Preferred omega-n fatty acids have 5 or 6 double bonds. In one embodiment of the present invention the omega-n fatty acid is selected from the group consisting of (all-Z)-5,8,11,14,17-eicosapentaenoic acid (EPA) and docosahexaenoic acid (DHA).Omega-n fatty acids can be isolated from fish oil.

CLA is conjugated linoleic acid. It can comprise several isomers. The two most abundant isomers of CLA are cis-9,trans-11-octadecadienoic acid and trans-10,cis-12-octadecadienoic acid. CLA can be made as described in U.S. Pat. No. 6,015,833.

The solubilizer according to the present invention is any solubilizer that increases the solubility of water soluble substances in lipophilic substances. In one embodiment of the present invention the solubilizer according to the present invention is selected from the group consisting of propylene glycol, a polysorbate (E 432 to E 436), a lecithin and a food emulsifier such as sugar esters, polyglycerol esters, mono-diglycerides and esters of mono-diglycerides. In one embodiment of the present invention the solubilizer according to the present invention is propylene glycol.

The addition of water soluble sweeteners to lipids suitable for human consumption improves the acceptance for direct oral consumption of such lipids. The sweeteners mask the oily taste and prevent an oily mouthfeel. The sweeteners work synergistically with other added flavours. Especially after consumption of oil there is an oily coating in the mouth which is an unpleasant taste sensation for the majority of the consumers.

With the combination of sweeteners and flavours it is possible to consume lipids suitable for human consumption in the most concentrated form (pure lipid). There is no need for special formulations such as soft gelatine capsules, emulsions or syrups which only increase costs and also increase the serving size.

The state-of-art formulations are pure lipids with oil soluble flavours. Such formulations have no balanced profile, because human beings expect a sweet taste in combination with fruit-like flavours. Especially children do not accept a flavoured oil that has not a balanced, sweet sensory profile.

The use of propylene glycol is already state of the art for the solubilization of antioxidant formulations in oils or for the solubilization of oil soluble flavours in aqueous matrices. Surprisingly it was found that propylene glycol can also solubilize water soluble sweeteners in lipids suitable for human consumption and give an intense sweet taste to such lipid systems (only poor contact of lipids to the taste buds). Surprisingly it was found that this sweet taste can mask the oily perception of pure lipids at oral consumption. Crystallization or separation of the water soluble compounds in the lipid can be avoided.

The composition according to the present invention can be used in nutritional supplements such as liquid flavoured lipids (in bottles) which are directly consumed via spoon or mixed into food products such as yogurts/cereals etc. Further applications are chewable capsules and formulated supplements such as syrups or emulsions.

The composition according to the present invention can also be applied in all kind of formulated food and beverage products in which a taste masking is needed.

In one embodiment of the present invention the lipid suitable for human consumption is selected from the group consisting of lipids containing omega-3 fatty acids such as fish oil, algae oils or vegetable oils, lipids containing omega-3/6/9 fatty acids, conjugated linoleic acid rich lipids, sterols and sterol esters, carotenoids and other fat soluble vitamins such as vitamins A, D, E, K and phospholipids.

In one embodiment of the present invention the flavour is selected from the group consisting of a flavour that is associated with a sweet taste profile such as a fruit flavour, vanilla, chocolate, coffee or a confectionery/beverage flavour and combinations thereof

In one embodiment of the present invention the sweetener is any water soluble sweetener such as sucralose (E 955), aspartame (E 951), acesulfame K (E 950), stevia, thaumatin (E 957), neohesperidin DC (E 959), saccharin (E 954), cyclamate (E 952), etc. Preferred sweeteners are sucralose, stevia and thaumatin which exhibit a long lasting sweet taste.

In one embodiment of the present invention the solubilizer is any solubilizer that is oil soluble and that can dissolve water soluble ingredients, a preferred solubilizer is propylene glycol. Other solubilizers are polysorbates (E 432-E 436), lecithins and other food emulsifiers

The composition according to the present invention can comprise further additives such as food grade antioxidants or food grade colourants. These additives can be used in order to improve the shelf life (antioxidant) or to improve consumer acceptance (carotenoids in an orange flavoured oil to exhibit same colour as orange juice).

In one embodiment of the present invention the composition according to the present invention has the following composition (in % by weight): 0.01% sucralose, 0.09% propylene glycol, 0.25% orange flavour oil soluble, 99.65% CLA-triglyceride.

In one embodiment of the present invention the composition according to the present invention has the following composition (in % by weight): 0.001-0.5% sweetener (e. g. sucralose), 0.01-2% solubilizer (e. g. propylene glycol), 0.01-2% flavour and 95.5-99.97% lipid.

The composition according to the present invention may be made according to the following process. The sweetener is dissolved in propylene glycol preferably at a temperature of 40 to 80° C. This solution is cooled down to ambient temperature. Flavour and sweetener are blended and the blend is dissolved in oil at ambient temperatures. Alternatively the warm sweetener solution in propylene glycol can be blended directly into the oil.

### EXAMPLES

Formulations tested (amounts in % by weight) and results obtained:

| Formulation | BK121 | BK122 | BK123 | BK124 | BK125 | BK126 | BK127 | BK128 | BK129 |
|---|---|---|---|---|---|---|---|---|---|
| Sucralose | 0.005 | 0.005 | 0.005 | 0.01 | 0.01 | 0.01 | 0.025 | 0.025 | 0.025 |
| Propylene | 0.095 | 0.095 | 0.095 | 0.09 | 0.09 | 0.09 | 0.075 | 0.075 | 0.075 |
| glycol | | | | | | | | | |
| Flavour | 0 | 0.25 | 0.5 | 0 | 0.25 | 0.5 | 0 | 0.25 | 0.5 |
| Tonalin ® | 99.90 | 99.65 | 99.40 | 99.90 | 99.65 | 99.40 | 99.90 | 99.65 | 99.40 |
| TG 80 | | | | | | | | | |
| taste | | | | | | | | | |
| evaluation | | | | | | | | | |
| rancidity | 0.25 | 0.13 | 0.13 | 0.25 | 0.13 | 0.13 | 0.25 | 0 | 0 |
| (control = 0.5) | | | | | | | | | |
| Oily, | 1.00 | 0.63 | 0.25 | 0.63 | 0.38 | 0.38 | 0.38 | 0.33 | 0.17 |
| cardboard | | | | | | | | | |
| (control = 1.9) | | | | | | | | | |
| sweetness | 1.00 | 0.88 | 1.13 | 1.75 | 1.50 | 2.00 | 1.88 | 2.17 | 2.67 |
| (control = 0.0) | | | | | | | | | |

Control was pure Tonalin® TG 80

Flavour used: Saftorange Typ 08368AV, obtainable from the German company Curt Georgi

Sucralose was obtained from the company Tate & Lyle, UK

Tonalin® TG 80 was obtained from Cognis GmbH, Monheim, Germany

Tonalin TG 80 is a triglyceride comprising about 80% (area-% determined by gas chromatography) conjugated linoleic acid moieties (of all fatty acid moieties present); the conjugated linoleic acid is a 1:1-mixture of cis9,trans11-octadecadienoic acid and trans10,cis12-octadecadienoic acid

Sensory evaluation was carried out after 7 days of storage.

Scores:

0=no taste

1=significant taste perception

2=strong taste perception

3=very strong taste

All samples with the sweetener solution showed a significant reduction in oily, cardboard and rancid taste. The dosage of 0.005% by weight sucralose resulted in a significant sweet taste. Dosages of 0.01% by weight −0.025% by weight resulted in a strong sweet taste profile. Typical soft drink formulations contain approximately 0.02% by weight of sucralose. I. e. the dosage tested is comparable to beverage products.

An increase in flavour concentration at constant sucralose concentration resulted in increased sweetness and in a reduced oily flavour. This shows a synergistic effect of the combination of sucralose and flavour. In order to reduce oily taste it is possible to increase the concentration of sucralose (BK121 to BK124) or to add flavour (BK121 to BK122).

1. A composition comprising
at least one lipid suitable for human consumption,
at least one water soluble sweetener, in which at least 2 g sweetener are soluble in 1 l of water at a temperature of 20° C., and
at least one solubilizer.

2. The composition of claim 1, wherein the at least one lipid suitable for human consumption comprises a triglyceride of a fatty acid.

3. The composition of claim 2, wherein the triglyceride of a fatty acid is selected from the group consisting of
a triglyceride comprising at least 50% by weight, of all fatty acid moieties of the triglyceride, conjugated linoleic acid moieties selected from the group consisting of cis9,trans11-octadecadienoic acid and trans10,cis12-octadecadienoic acid and a mixture of cis9,trans11-octadecadienoic acid and trans10,cis12-octadecadienoic acid, and
a triglyceride comprising at least one acyl moiety derived from an omega-n fatty acid, n being 3, 6 or 9.

4. The composition of claim 1, wherein the at least one water soluble sweetener is selected from the group consisting of sucralose (E 955), aspartame (E 951), acesulfame K (E 950), stevioside, thaumatin (E 957), neohesperidin DC (E 959), saccharin (E 954) and cyclamate (E 952).

5. The composition of claim 1, comprising the at least one lipid suitable for human consumption at a concentration of 1 to 99.9945% by weight.

6. The composition of claim 1 comprising the at least one water soluble sweetener at a concentration of 0.0005 to 1.0% by weight of the at least one lipid.

7. The composition of claim 1 comprising the at least one solubilizer at a concentration of 0.005 to 5.0% by weight of the at least one lipid.

8. The composition of claim 1, further comprising at least one compound selected from the group consisting of a phytosterol, a phytosterol ester, a carotenoid, a fat soluble vitamin and a phospholipid.

9. The composition of claim 1 further comprising at least one flavour.

10. The composition of claim 9, wherein the at least one flavour is suitable for flavouring food, at a concentration of 0.001 to 5% by weight.

11. The composition of claim 1 further comprising at least one additive selected from the group consisting of antioxidants and colorants, wherein the antioxidant is selected from the group consisting of tocopherols, rosemary extracts and ascorbyl esters, and wherein the colorant is a colorant suitable for coloring food.

12. A method of making the oily taste of a lipid suitable for human consumption, the method comprising adding the composition of claim 1 to a lipid suitable for human consumption.

13. The composition of claim 1, comprising the at least one lipid suitable for human consumption at a concentration of 50 to 99.9945% by weight and
the at least one water soluble sweetener at a concentration of 0.0005 to 1.0% by weight (preferably 0.001 to 0.5% by weight) of the at least one lipid and
the at least one solubilizer at a concentration of 0.005 to 5.0% by weight of the at least one lipid.

14. The composition of claim 3, wherein n has a value of 3.

15. The composition of claim 4, wherein the at least one water soluble sweetener is selected from the group consisting of sucralose, stevioside and thaumatin.

16. The composition of claim 5, comprising the at least one lipid suitable for human consumption at a concentration of 50 to 99.9945% by weight.

17. The composition of claim 6, comprising the at least one water soluble sweetener at a concentration of 0.001 to 0.5% by weight.

18. The composition of claim 8, wherein the carotenoid comprises beta-carotin, lutein, zeaxanthin or lycopen in free form or in ester form.

19. The composition of claim 8, wherein the fat soluble vitamin comprises vitamin A, D, E or K.

20. The composition of claim 11, wherein the composition comprises an antioxidant at a concentration of 0.01-0.5% by weight and a colorant at a concentration of 0.2 mg/g to 200 mg/g.
